(19) United States
(12) Patent Application Publication
(10) Pub. No.: US 2009/0094392 A1
(43) Pub. Date: Apr. 9, 2009

(54) System and Method for Data Operations in Memory

(76) Inventor: Mikio Sakurai, Tsukuba (JP)

Correspondence Address: FAY KAPLUN & MARCIN, LLP, 150 BROADWAY, SUITE 702, NEW YORK, NY, 10038, US

(21) Appl. No.: 11/866,806

(22) Filed: Oct. 3, 2007

(51) Int. Cl. G06F 13/30

(52) U.S. Cl. 710/66

(57) ABSTRACT

A system and method for receiving, by a memory device, data in a first format, transforming, by the memory device, the data from the first format to a second format and outputting the data in the second format. An integrated circuit having at least one data segment and a logic circuit receiving and transforming data from a first format to a second format.

### BACKGROUND

Data compression is commonly implemented in order to facilitate the storage of various types of data that are excessively large in raw, uncompressed form. Such data types may include still images, video, audio and various other types of data that may be desirable to compress.

The application of data compression algorithms can be time-consuming, depending on the algorithm used and the amount of data involved. Further, while in operation, data compression algorithms require significant processor power and memory space to operate properly.

### SUMMARY

A method for receiving, by a memory device, data in a first format, transforming, by the memory device, the data from the first format to a second format and outputting the data in the second format.

### DESCRIPTION OF THE DRAWINGS

FIG. 1 shows an exemplary embodiment of the present invention including a system implementing a memory device to aid in processing of data.

FIG. 2 shows an alternative exemplary embodiment of a memory device according to the present invention.

FIG. 3a shows an alternative exemplary embodiment of a system implementing a memory device to aid in processing of data.

FIG. 3b shows a further exemplary embodiment of a system implementing a memory device to aid in processing of data.

FIG. 4 shows an exemplary embodiment of a memory device including a camera interface to aid in processing of a data.

FIG. 5 shows an exemplary embodiment of a memory device including a camera interface and JPEG image processing logic to aid in processing of data.

### DETAILED DESCRIPTION

Embodiments of the present invention may be further understood with reference to the following description and the appended drawings, wherein like elements are referred to with the same reference numerals. The exemplary embodiments of the present invention describe systems and methods for improving the efficiency of various data compression processes. The exemplary embodiments perform a portion of a compression algorithm using logic located in a memory, rather than using a processor, thus reducing demands on the processor. The exemplary systems and methods will be further discussed in detail below.

Those skilled in the art will understand that while the exemplary embodiments are described with reference to a data compression scheme, embodiments of the present invention are not limited to use with data compression schemes. As will be described in greater detail below, the exemplary embodiments provide for the manipulation (e.g., reordering) of raw data in memory (e.g., upon the writing of the data into memory and/or upon the reading of the data from the memory). Thus, embodiments of the present invention may be implemented as part of any data operation that manipulates the data stored in memory. Furthermore, the manipulation of the data in the memory may be the entire process. That is, the manipulation of the data is not required to be part of a larger process such as data compression, but may be the end in itself (e.g., for the efficient storage of the data so that it may be used with multiple processes).

In addition, it is noted that the exemplary embodiments are described with reference to a random access memory (“RAM”) device, specifically a Dynamic RAM (“DRAM”) device. However, those skilled in the art will also understand that the present invention may be implemented in any type of memory device.

Many types of data, and particularly still image data, video data, and audio data, may require a significant amount of storage space. Therefore, it is desirable to compress such data in order to reduce the required space. A variety of compression algorithms have been developed for this purpose. Examples of compression algorithms include JPEG, GIF and PNG for still images; MPEG-4, WMV and AVS for video data; and MP3, AAC and WMA for audio data. The exemplary embodiments discussed below will be described with reference to the JPEG image compression algorithm; however, the same principles are equally applicable to various other compression algorithms.

The JPEG image compression algorithm, which will be referenced in the exemplary embodiments to be described below, operates by grouping components into 8×8 blocks and performing data processing on each 8×8 block. In raw form, image data is received in YUV format, where “Y” represents luminance (i.e., brightness) and “U” and “V” represents chrominance (i.e., color, split into blue and red components). A data stream coming from an image sensor (e.g., a camera) will be in the form “YUYVYUYVYUYV . . . ” However, data is processed by grouping each of the image components and performing operations on like components, i.e., processing all Y components in one group, all U components in another group, and all V components in a third group. Thus, operations are performed on 8×8 blocks where each component in the block is exclusively one of a Y component, a U component, or a V component.

Typically, when image data is being processed to be stored to JPEG, it is received from a source (e.g., a digital camera) through an interface and sent to a system's processor. The processor temporarily stores the data in a memory (e.g., a DRAM device) in its default “YUYVYUYVYUYV . . . ” format, until the processor is ready to process the data. When the processor is ready to process the data, the memory returns the data to the processor. The processor sorts and reorders the data into groups of “YYYY,” “UUUU,” and “VVVV,” splits these groups into 8×8 blocks, and performs the remainder of the JPEG algorithm on the 8×8 blocks. Once the algorithm is complete, the finished JPEG file may be stored to volatile memory (e.g., RAM, DRAM, Synchronous DRAM (“SDRAM”), Extended Data Out RAM (“EDORAM”), Double Data Rate RAM (“DDRRAM”), DDR2RAM, etc.) and/or non-volatile memory (e.g., a compact flash (“CF”) card, a secure digital (“SD”) card, a hard drive, etc.). Those skilled in the art will understand that while these devices are referred to herein as storage devices, these types of devices may also be considered memory devices as that term is used in this description.

In another implementation, the processor reorders the data upon receipt from the image source and before it is temporarily stored to the memory device. After the data is returned from the memory to the processor, the remainder of the JPEG algorithm is performed. In either case, all data processing for implementing the JPEG compression algorithm is performed by the processor.

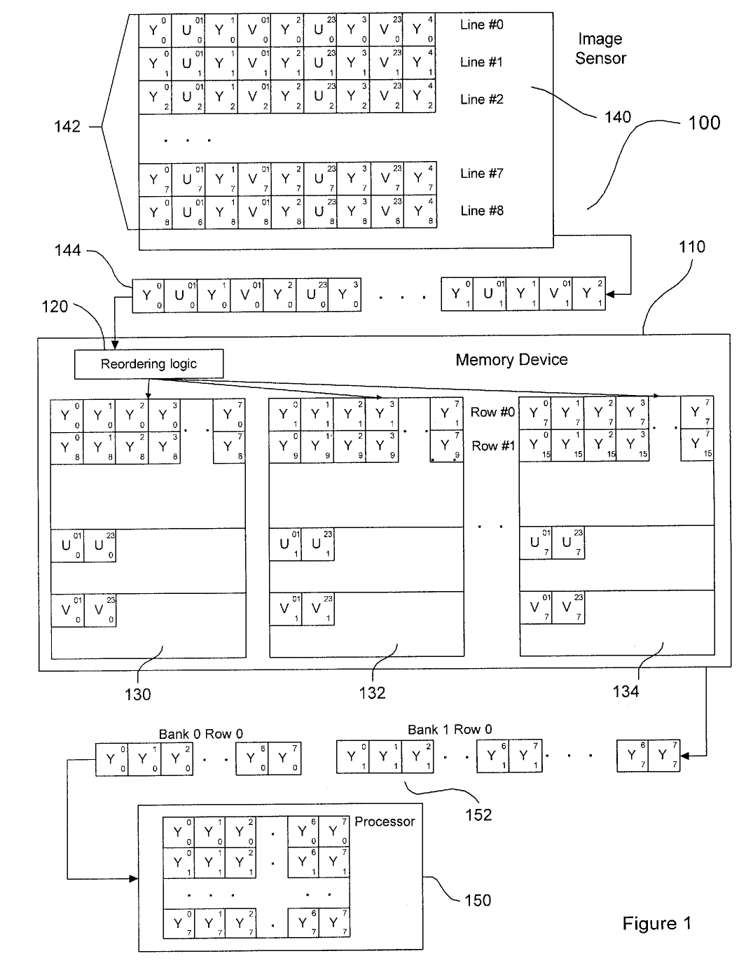

FIG. 1 shows an exemplary embodiment of a system 100 that includes an image sensor 140, a memory device 110 and a processor 150, wherein the memory device 110 performs a manipulation of the data to aid in processing of the JPEG image compression algorithm. The memory device 110 includes reordering logic 120 and data segments 130, 132, 134. The specific number of data segments may vary among different implementations. In this exemplary embodiment, eight segments 0-7 are used due to the specifics of the JPEG algorithm, though for illustrative purposes only three are shown. In this exemplary embodiment, each of the data segments 130, 132 and 134 are shown as physically separated components. However, those skilled in the art will understand that the data segments may be within a single memory component based on a virtual separation of the segments, e.g., each segment is assigned a range of column addresses within the memory.

The image sensor 140 collects the image data as shown by the exemplary image data 142. The image sensor 140 may be any device that is capable of collecting image data 142 such as a camera, etc. The raw image data 142 is sent to the memory 110. As described above, the raw image data 142 may be sent from the image sensor 140 to the memory 110 via the processor 150. The data received by the memory 110 is in the “YUYVYUYVYUYV . . . ” format 144, as previously discussed. The reordering logic 120 sorts the received data 144 into separate groups of Y components, U components and V components.

The reordering logic 120 may be any combination of hardware and/or software implemented in the memory 110 that is configured to perform the functionality described herein. For example, the memory device 110 may have one or more processing components or circuitry that is configured to execute firmware stored in the memory device 110. This circuitry and/or firmware may be modified to perform the functionality described for the reordering logic 120. In addition, it may be that the reordering logic is implemented as hardware and/or software that is external to the memory 110 such as on a motherboard or other components of a device in which the memory 110 is included.

A group of eight Y components is placed into the first row of the first segment 130. In this example, the partition of the raw data into the component data is based on the row address within the memory device. Thus, the first group of eight Y components Y₀⁽⁰⁻⁷⁾ is shown as being stored in the first segment 130, row address #0. It is noted that other partition schemes may also be used. The next group of eight Y components (e.g., Y₁⁽¹⁻⁷⁾) is placed into the first row (row address #0) of the second segment 132. This process continues until the eighth group of eight Y components (e.g., Y₇⁽⁰⁻⁷⁾) has been placed into the first row (row address #0) of the eighth segment 134.

Subsequently, the next group of eight Y components (e.g., Y₈⁽⁰⁻⁷⁾) is placed in the second row (row address #1) of the first segment 130, continuing as above and returning to the first segment 130 on every eighth group. The U components and V components are grouped in the same manner; because the “YUYV” pattern contains two Y components for each single U component and V component, there will be twice as many Y components to sort, and accordingly there will be twice as many rows of Y components in total. This process is illustrated in FIG. 1. It is again noted, however, that the details of this process pertaining to the JPEG algorithm are exemplary, and it is presented as an illustration of how embodiments of the present invention may be applied to that particular data compression method.

After the entirety of the received data has been sorted, the sorted data 152 may be sent to the processor 150 for the remainder of the JPEG processing. In one example, the data from the memory 110 is read using a burst segment interleave method. Other methods of reading the data in the memory 110 may also be used. For example, the first row (row address #0) of the first segment 130 is sent (e.g., Y₀⁽⁰⁻⁷⁾), followed by the first row (row address #0) of the second segment 132 (e.g., Y₁⁽⁰⁻⁷⁾), continuing in order until the first row (row address #0) of the eighth segment 134 (e.g., Y₇⁽⁰⁻⁷⁾). These eight rows of the eight segments form an 8×8 group as described above. Subsequently, the second row (row address #1) of the first segment 130 is sent (e.g., Y₈⁰⁻⁷⁾), followed by the second row (row address #1) of the second segment 132 (e.g., Y₉⁽⁰⁻⁷⁾), and so forth. Thus, the processor 150 receives the sorted image data 152 so that the JPEG compression may be performed on the sorted image data 152. By freeing the processor 150 of the need to reorder the data, data can be moved from the memory 110 to the processor 150 more quickly, and the processor 150 can perform the remainder of the JPEG processing more quickly as well.

In the above example, it is noted that the raw image data 144 is shown as being received from the image sensor 140. It is noted that the memory device 110 does not need to receive the raw image data 144 directly from the image sensor 140. For example, the memory device 110 may be a portion of a device that is connected to a network. The raw image data 144 may be received over the network for further processing at the network device including the memory device 110.

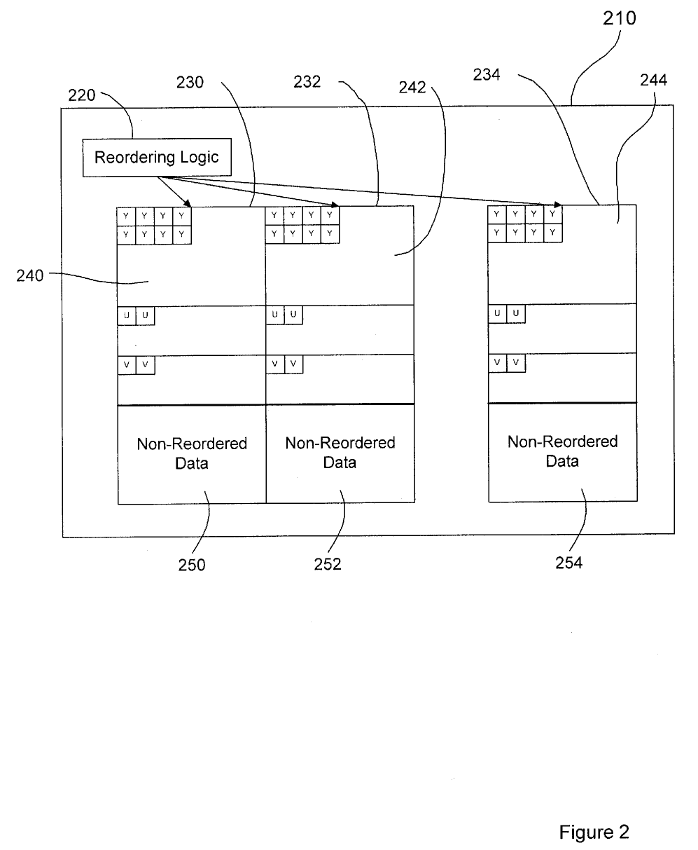

FIG. 2 shows an alternative exemplary embodiment of a memory device 210. Like the memory device 110 of FIG. 1, the memory 210 includes a plurality of data segments 230, 232, 234. As previously discussed for the memory device 110, the specific number of data segments may vary depending on the specific implementation. The memory device 210 also includes reordering logic 220 that may operate in a similar manner as described above for the memory device 110.

The memory 210 differs from the memory 110 in that the data segments 230, 232, 234 are subdivided into reordering areas 240, 242, 244, and non-reordering areas 250, 252, 254. Data that has been sorted by the reordering logic 220 is stored in reordering areas 240, 242, 244. Non-reordering areas 250, 252, 254 are reserved for storing data that has not been sorted by the reordering logic 220, but rather are reserved for unrelated tasks or data.

For example, the memory device 210 may be part of a digital camera. In addition to storing the image data that is collected by the digital camera, the memory device 210 (e.g., DRAM device) may also store the operating system kernel for the camera when the camera is operating. The operating system kernel may control various camera operations such as zooming, user interfaces such as a display screen, flash control, etc. The operating system kernel data may not need to be sorted in the same manner as the raw image data. While the operating system kernel could be stored on the exemplary embodiment of the memory device 110 shown in FIG. 1, as the image data is stored, the operating system kernel data may have to be replaced or moved within the memory device 110 to another address. This exemplary embodiment alleviates the possibility of having to replace the operating system data to a new address, thereby allowing the processor to simultaneously use the same memory device 210 for multiple tasks, e.g., operating system storage at the addresses intended by the processor and temporary storage of sorted image data.

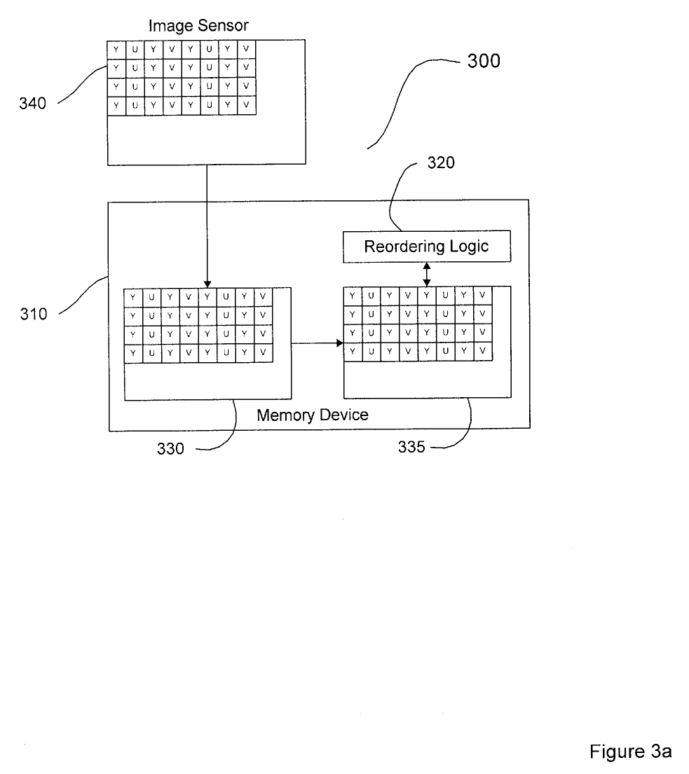

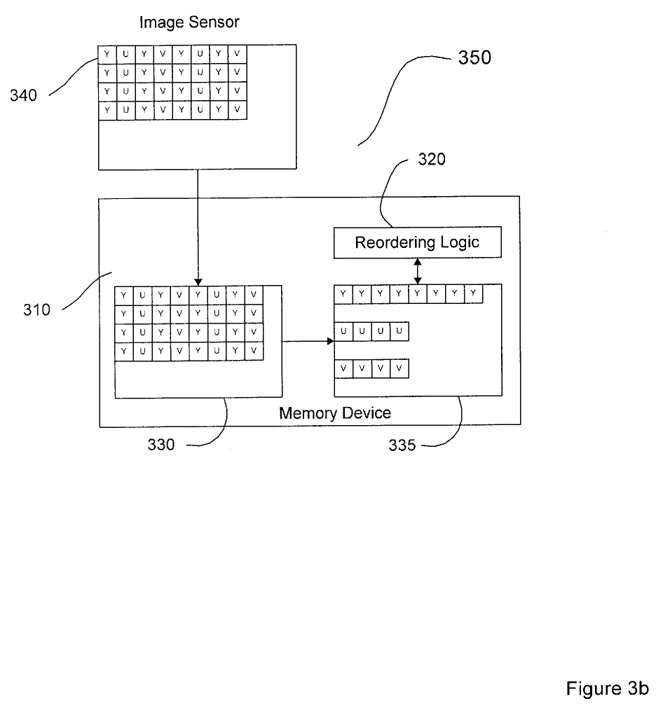

FIG. 3a shows an alternative embodiment of a system 300 for manipulating data in a memory 310. Similar to the above described exemplary embodiments, the data may be, for example, image data received from an image sensor 340. However, as also described above, embodiments of the present invention are not limited to image data. The memory 310 may include a plurality of first data segments 330 and second data segments 335. As previously discussed, the specific number of first and second data segments 330 and 335 may vary depending on the specific implementation of the memory 310. For illustrative purposes, only a single first data segment 330 and second data segment 335 is shown in FIG. 3. In this exemplary embodiment, the first data segment 330 may be, for example, a DRAM device, while the second data segment 335 may be, for example, a Static RAM (“SRAM”) device. Thus, in this exemplary embodiment, the memory device 310 may include two or more types of memory. However, those skilled in the art will understand that the use of DRAM and SRAM is only exemplary and that other types of memory may also be used, e.g., SDRAM, EDORAM, DDRRAM, DDR2RAM, etc.

The memory 310 initially stores image data in the order in which it is received. Thus, the raw image data that is received from the image sensor 340 may be stored in the same format in the first data segment 330. Rather than reordering the data upon receipt, a reordering logic 320 sorts the data when it is being read from the memory 310 (e.g., by a processor).

In this exemplary embodiment, when the memory 310 receives a read command for the image data that is stored in the data segment 330, the image data is copied to the second data segment 335. This image data that is copied to the second data segment 335 may remain in its raw image format. However, as the data is read out to the processor, the reordering logic 320 generates the memory address at which the data should be read out to create the reordered data that is read out to the processor. Thus, the data that is received by the processor is the reordered data similar to the reordered data described above with reference to FIG. 1. In this example, because the SRAM is very fast, the read out of the data will appear as a standard burst read to the processor and the processor will receive the reordered image data for further processing.

FIG. 3b shows another alternative embodiment of a system 350 for manipulating data in a memory 310. The system 350 includes the same components as described above for the system 300 of FIG. 3b. The difference between the two exemplary embodiments is that in the system 350, when the read command is received by the memory 310 and the data is copied from the first data segment 330 to the second data segment 335, the reordering logic 320 generates the reordered data and this reordered data is stored in the reordered format in the second data segment 335. Thus, when the data is read out of the second data segment 335, it is read out in the same format that it is stored in the second data segment 335, i.e., the reordered format.

It should be noted that in the exemplary embodiments of FIGS. 3a and b, the data may be read out of memory 310 in both the reordered format and the raw format. That is, as described above, the data may be read out in the reordered format from the second data segment 335. However, it may also be possible to read out the raw data that is stored in the first data segment 330 to retain the data in its raw format. This may be useful, for example, when the data is compressed using a lossy compression such as JPEG. For example, a user may desire to store the JPEG compressed image, but may also desire to store the original image data for other use. Thus, the raw image data stored in the first data segment 330 may be copied to any other type of volatile or non-volatile memory device.

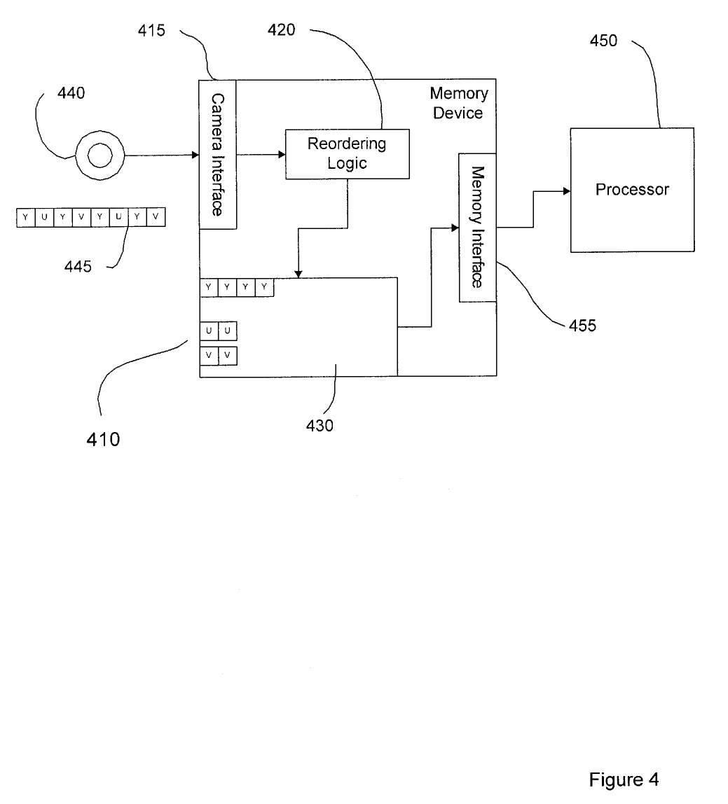

FIG. 4 shows an alternative exemplary embodiment of a memory device 410 including a camera interface 415. The memory device 410 may generally operate in a manner similar to any of the memory device 110, 210 and 310 described above to aid in the processing of data. However, in addition to the functionalities described above, the memory device 410 also includes a camera interface 415. Thus, in this exemplary embodiment, the raw image data 445 collected by the camera 440 may go directly to the memory device 410 via the camera interface 415. That is, the raw image data 445 does not need to interface through the processor 450 in order to be stored by the memory device 410. This may further reduce the processing load on the processor 450 by eliminating the raw image data traffic that goes through the processor 450.

To continue with the example, the camera 440 will collect the raw image data 445 and send the raw image data 445 to the camera interface 415 of the memory device 410. The camera interface 415 may be a component implemented in the memory device 410 and/or software code implemented in the memory device 410 that is configured to receive the raw image data 445 from the camera and perform any necessary steps so that the data may be accepted by the memory 410.

In this exemplary embodiment, the memory device 410 includes the reordering logic 420 that is used to reorder the raw image data 445 and store the reordered image data in the data segment(s) 430. This process of reordering the raw image data 445 into the reordered image data may be any of the processes described above with reference to the exemplary embodiments of FIGS. 1-3. Thus, if the reordering process(es) described with reference to FIGS. 1-2 is implemented, the reordering takes place when the data is written to the memory device 410. In contrast, if the reordering process(es) described with reference to FIGS. 3a-b is implemented, the reordering takes place when the data is read from the memory device 410.

As shown in FIG. 4, the memory device 410 also includes a standard memory interface 455 that is used to interface with the processor 450 for any standard read/write operations between the processor 450 and the memory device 410. The memory device 410 may also include control logic that may generate an interrupt that is sent to the processor 450 when the entire image data is stored in the memory 410. That is, when the memory device 410 has stored the entirety of the image data, the memory device 410 may send the interrupt to the processor 450. This interrupt signals the processor 450 that the entire image data has now been stored n the memory device 410 and that the processor 450 may begin any image processing (e.g., the remainder of the JPEG compression) on the stored data. Thus, the processor 450 does not need to be involved with the storing of the data nor with interfacing with the memory device 410 until all the data is stored.

Those skilled in the art will understand that the above description of the exemplary embodiment used a camera interface 415 as the interface for accepting data from an external source. However, embodiments of the present invention are not limited to using a camera interface. The interface may be any type of interface that may be used for the memory device to accept data directly from an external source. Again, as described above, this data may be, for example, image data, video data, audio data or any type of data where additional processing will be performed on the data.

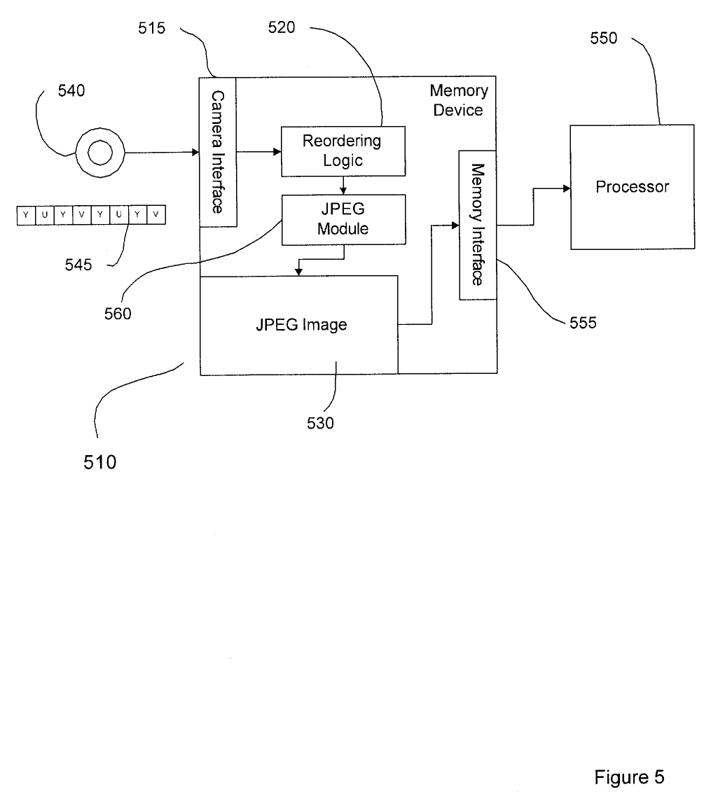

FIG. 5 shows another exemplary embodiment of a memory device 510 that includes a JPEG module 560. The memory device 510 includes the same basic components as described above for the memory device 410 including a camera interface 515 for directly accepting the raw image data 545 from the camera 545, the memory segment(s) 530, the reordering logic 520 and the standard memory interface 555. However, in this exemplary embodiment, the entirety of the JPEG compression may be carried out in the memory device 510 because the memory device 510 further includes the JPEG module 560. The JPEG module 560 includes the logic necessary to carry out the remaining steps of the JPEG compression algorithm that were carried out by the processor 450 in the example of FIG. 4. Thus, not only is the reordering step performed by the memory module 510, but all the steps of the JPEG compression are carried out in the memory module 510 and the JPEG image may be stored in the memory segment(s) 530. Thus, the processor 550 is completely eliminated from the creation of the JPEG image in the embodiment of FIG. 5. The JPEG image stored in the memory device 510 may then be copied to any type of volatile and/or non-volatile memory device.

Those skilled in the art will understand that the inclusion of the JPEG module 560 is only exemplary. That is, any type of data manipulation module may be included in the memory device to perform a data manipulation function that was carried out by the processor. This data manipulation is not limited to JPEG or data compression, but may be any functionality for modifying the raw data that is received by the memory device.

Those skilled in the art will also understand that the JPEG module 560 (or other data manipulation module) may be implemented in the memory device as a hardware component and/or as software code that executes to perform the functionality that is to be implemented by the module.

The exemplary embodiments described herein improved efficiency for data operations that are performed on data that is stored in a memory. That is, some (or all) of the processing for the data operations are offloaded from the processor to the memory device. In the exemplary embodiments, the data operation was data compression (e.g., JPEG compression). However, it will be apparent from the above description that embodiments of the present invention may be used with other types of data operations where some (or all) of the processing steps may be performed by the memory device.

The exemplary memory may be implemented within a device that is dedicated to a particular task (e.g., a digital camera, a digital video recorder, a digital audio recorder). By performing a portion of the data manipulation in the exemplary memory rather than in the processor, the specification of the processor may be such that it does not need to handle this functionality. As a result, a lower capability processor may be used, leading to a reduction in the cost of the device.

The exemplary memory may also be implemented in a general purpose computing device such as a personal computer (“PC”). In this type of environment, the exemplary memory device will also relieve the processor from certain processing tasks, thereby allowing the processor to be used for other tasks that may increase the speed and efficiency of the computing device.

It will be apparent to those skilled in the art that various modifications may be made in the present invention, without departing from the spirit or scope of the invention. Thus, it is intended that the present invention cover the modifications and variations of this invention provided they come within the scope of the appended claims and their equivalents.

What is claimed is:

1. A method, comprising:
receiving, by a memory device, data in a first format;
transforming, by the memory device, the data from the first format to a second format; and
outputting the data in the second format.

2. The method of claim 1, wherein the transforming comprises reordering the data.

3. The method of claim 1, wherein the transforming comprises writing the data into the memory device in the first format and reading the data from the memory device in the second format.

4. The method of claim 1, wherein the transforming comprises writing the data into the memory device in the second format.

5. The method of claim 1, wherein the data is one of still image data, video data and audio data.

6. The method of claim 1, wherein the transforming of the data is performed for a data compression operation.

7. The method of claim 6, wherein the data compression operation is one of a JPEG compression, a GIF compression, a PNG compression, an MPEG compression, a WMV compression, an AVS compression, an MP3 compression, an AAC compression and a WMA compression.

8. The method of claim 1, wherein the data is image data including luminance components and chrominance components, the second format is a reordered format including a grouping of the luminance components and the chrominance components.

9. The method of claim 1, wherein the data is image data and the second format is a JPEG image format.

10. An integrated circuit, comprising:
at least one data segment; and
a logic circuit receiving and transforming data from a first format to a second format.

11. The integrated circuit of claim 10, wherein the logic circuit receives the data in the first format during a write operation, transforms the data into the second format and stores the data in the second format.

12. The integrated circuit of claim 10, wherein the logic circuit receives the data in the first format during a read operation, transforms the data from the first format to the second format, and outputs the data in the second format.

13. The integrated circuit of claim 10, wherein the at least one data segment is a plurality of data segments, wherein each data segment stores a portion of the data.

14. The integrated circuit of claim 10, wherein the at least one data segment includes a first portion storing the data in the second format and a second portion storing additional data not transformed by the logic circuit.

15. The integrated circuit of claim 10, further comprising:
an interface for receiving the data in the first format.

16. The integrated circuit of claim 10, wherein the first format is a raw data format and the second format is a format used in a data operation.

17. The integrated circuit of claim 16, wherein the data operation is a data compression operation.

18. A device, comprising:
a data collection component collecting data in a first format;
a memory component storing the data in one of the first format and a second format and outputting the data in the second format; and
a processor receiving the data from the memory component.

19. The device of claim 18, wherein the memory component receives the data in the first format and stores the data in at least one data segment in the second format.

20. The device of claim 18, wherein the memory component transforms the data from the first format to the second format.

21. A device, comprising:
means for collecting data in a first format;
means for storing the data in one of the first format and a second format and outputting the data in the second format; and
means for receiving the data from the storing means.

22. An integrated circuit, comprising:
at least one data segment; and
means for receiving and transforming data from a first format to a second format.
